(19) United States
(12) Patent Application Publication
(10) Pub. No.: US 2009/0315314 A1
(43) Pub. Date: Dec. 24, 2009

(54) Glue strip, bundle of glue strips and methods related thereto

(76) Inventor: Arthur Quaranta, Wilmington, NC (US)

Correspondence Address: COOPER & DUNHAM, LLP, 30 Rockefeller Plaza, 20th Floor, NEW YORK, NY, 10112, US

(21) Appl. No.: 11/919,049

(22) PCT Filed: May 5, 2006
(86) PCT No.: PCT/SE2006/050106

§ 371 Date: Oct. 23, 2007

(30) Foreign Application Priority Data
May 10, 2005 (SE) 0501128-3

(51) Int. Cl. B42D 3/00; B42C 9/00; B32B 38/10

(52) U.S. Cl. 281/21.1; 412/3; 156/250

(57) ABSTRACT

The invention relates to a glue strip (4) adapted for application to the spine of a file-jacket blank. The glue strip is rigid at room temperature, so as to be inactive. According to the invention, one side of the glue strip is provided with a glue that is active at room temperature. The invention also relates to a bundle (6) of such glue strips. The invention also relates to a method of producing such a bundle (6) and to a method of producing a file jacket with the aid of the inventive glue strip. The invention also relates to a package of file-jacket blanks and glue strips. Finally, the invention also relates to a file-jacket blank.

### FIELD OF INVENTION

The present invention relates to a glue strip, to a bundle of such glue strips, to a method of producing such a bundle and to a method of producing a file jacket with the aid of one such glue strip.

According to a first aspect the present invention relates to a glue strip which is designed for application on the inside of the spine of a blank intended to form a file jacket, wherein the glue strip includes a glue whose softening temperature is higher than room temperature so that the glue will be inactive at room temperature.

According to a second aspect, the invention relates to a bundle of glue strips each of which includes a glue whose softening temperature is higher than room temperature.

According to a third aspect the invention relates to method of producing a bundle of glue strips where each glue strip includes a glue whose softening temperature is higher than room temperature.

According to a fourth aspect the invention relates to a method of manufacturing a file jacket which includes a front sheet, a rear sheet, or backing sheet, and a spine which extends between said sheets with glue adhered to the inside of the spine, said glue having a softening temperature which is higher than room temperature.

According to a fifth aspect the invention relates to a package of file-jacket blanks.

According to a sixth aspect the invention relates to a file-jacket blank.

By room temperature is meant in the present application the temperature that occurs normally in an office environment, and is assumed to lie in the range of 15°-30° C. The majority of glues have an adhesive function that is dependent on temperature. Such a glue is rigid beneath a given temperature and has no adhesiveness. The glue becomes successively softer at increasing temperatures and obtains first a weak adhesiveness and gradually a strong adhesiveness. By weak adhesiveness is meant a reduced gluing effect, where adhesion takes place but with a force which enables the adhered objects to be separated without damaging them. The glue is highly effective at higher temperatures, wherewith the glue joint can not be broken without danger of damaging the glued objects. This terminology in the present application with the purport just mentioned. By jacket blank or file-jacket blank is meant in this application a unit that consists of a front sheet, a rear sheet, and a spine located between said sheets. By file jacket is meant a jacket blank that has glue on the inside of the spine. By file is meant a file jacket that includes a bundle of sheets fastened in the jacket.

### BACKGROUND OF THE INVENTION

A technique for the manufacture of folders known generally for several decennia is based on the provision of a folder jacket and a bundle of sheets fastened in the jacket. The jacket consists of a front sheet, a rear sheet and a spine which extends between said sheets. Applied to the inner surface of the spine is a glue which is inactive at room temperature, in other words the glue is rigid and has no gluing effect or adhesiveness. The bundle of sheets is secured by inserting the bundle against the spine so that one edge of each sheet will abut the glue. That part of the spine to which the glue is applied is heated so as to soften the glue, wherewith the sheet edges are pressed slightly into the glue. After the glue has then cooled, the sheet bundle is held firmly in the file jacket, resulting in the manufacture of a finished file. Files manufactured in this way are particularly suited for short series in the order of some single files or some tens of files. The process is also suited in respect of larger series of some hundreds or some thousands of files. Depending on the magnitude on the series concerned, the insertion of sheets and the bonding process may be automated to different degrees. The file jacket is normally provided with the glue strip fastened to the spine of the file jacket.

The production of this type of file is normally carried out by a user who wishes to present information material in a tidy and attractive manner, by binding a file.

The user will often desire to include on the jacket some form of graphics, for instance a title or some other text that represents the contents of the file, a picture and/or a logotype.

As opposed to booklets and other material that is produced in large series, in which both contents and front page can be pre-printed with good production economy, the situation is slightly different when information material is to be produced in a relatively small series. In such cases it is seldom cost effective to use file jackets on which graphic has been printed from the very beginning. The typical user who produces files of the kind concerned will have a number of blank jackets in store. When a few files shall be produced and when it is desired to show graphics on the jacket, there is a need to enable the graphics to be applied in an inexpensive manner with regard to the limited size of the series. The natural choice in this respect is to apply the graphics from a printer or the like prior to binding the file. However, this results in a problem caused by the presence of the glue strip on the spine of the file jacket. The glue strip typically has a thickness of 0.5-1 mm and can present a problem in the printer, partly due to the thickness of the glue strip and partly because there is a risk that the heat developed during photo-copying will soften the glue. One object of the present invention is to overcome this problem.

### SUMMARY OF THE INVENTION

This object of the invention has been achieved by providing means that enable graphics to be applied prior to binding the file through the medium of a method of manufacturing such means and through the medium of a method of manufacturing a file jacket.

The object of the invention according to said first aspect has been achieved by means of a glue strip of a kind defined in the preamble of claim 1 and which includes the special features that the glue strip is provided on one side with a layer of another type of glue that has a softening temperature which enables it to be adhesive at room temperature.

With the aid of such a glue strip, glue can readily be applied to the spine of a file-jacket-blank. The glue strip is fastened adhesively to the inner surface of the spine with the aid of said different glue sort. This enables graphic to be first applied to the jacket blank and thereafter to apply the glue string and then to bind the file.

According to one preferred embodiment of the inventive glue strip, the layer of said different sort of adhesive is applied on one or more sections of the side of the glue strip. Application of said layer on the spine of a jacket blank is facilitated by the fact that the layer is not applied along the full length of the strip. Moreover, the adhesive force can be restricted to an appropriate level such as to allow the position of the glue strip to be easily adjusted in the event of the strip being positioned wrongly from the outset.

According to another preferred embodiment said layer includes three sub-layers, of which the softening temperature of a first sub-layer and a second sub-layer is the same as the softening temperature of the glue and a third sub layer is comprised of an intermediate carrying layer. In the case of a glue strip of this design the layer may be comprised of double-sided adhesive tape thereby facilitating application of the glue strip layer.

According to a further preferred embodiment the glue strip is provided with a woven fabric on that side which is opposite to the side provided with a layer of said different glue sort.

This woven fabric means that the force of adhesion on this side will decrease, therewith enabling this side of the glue strip to be readily released from a layer of said different glue sort. This makes handling of a bundle of glue strips to be achieved more easily.

According to another preferred embodiment the glue strip includes an indicating element.

This indicating element may, for instance, consist of an aluminium strip. The machines used for binding a file will include means that detect the presence of such an indicating element before allowing the binding operation to commence. The advantage of this embodiment resides in the possibility of also using the glue strip in such machines.

The object of the invention has also been achieved by the second aspect of the invention, by virtue of a bundle of glue strips of the type defined in the preamble of claim 6 having the special features whereby the glue strips lie mutually in adhesion with one another, side-by-side, wherein said adhesion is achieved by means of a layer of a different glue sort applied between each layer of mutually abutting sides, this different glue sort having a softening temperature which allows said different glue sort to be adhesive at room temperature.

Such a bundle of glue strips affords significant advantages in practice when wishing to apply a glue strip to the spine of a jacket blank. It is easy to keep an account of such a bundle and to remove a strip therefrom. The layer of adhesive glue will be protected by being situated between glue strips. There is thus no danger of this layer becoming unusable due to soiling or dirtying of the layer. The provision of glue strips in a bundle of this kind also enables the glue strips to be manufactured in a rational fashion.

According to one preferred embodiment of the inventive bundle said layer is provided on one or more sections of the mutually abutting sides of the glue strips.

According to another preferred embodiment each of said layers includes three sub-layers of which a first sub-layer and a second sub-layer have the given glue softening temperature and a third sub-layer that forms an intermediate carrying layer.

According to another preferred embodiment, each glue strip is provided with woven fabric on one of its sides.

Consequently, the layer of said different sort of glue will adhere on one side to the woven fabric on the glue strip and on the other side to a glue strip that has no woven fabric, this applying to each pair of mutually abutting sides of respective glue strips. This results in stronger adhesion. It can therewith be ensured with which strip the layer of said different sort of glue will remain adhered to a glue strip loosened from the bundle. Each glue strip loosened from the bundle will therewith have a side that includes a layer of said different glue sort and a side provided with a woven fabric.

The same advantages as those described above with respect to corresponding preferred embodiments of the inventive glue strip will also be afforded by the preferred embodiments of the bundle described above.

According to another preferred embodiment the bundle will include from five to fifty glue strips.

It is believed that this range encompasses the most appropriate number of glue strips that can be handled comfortably. The most suitable number of glue strips in the bundle is from 10 to 20 inclusive.

According to one embodiment, the bundle has a height of 5-50 mm, a width of 1-20 mm and a length of 100-400 mm.

With a bundle size dimensioned within these dimensional ranges, the glue strips will have dimensions that are well suited for application to a spine of a file-jacket blank.

According to another preferred embodiment, the bundle is included in an array of several bundles of mutually the same kind, where each bundle is firmly adhered to a substrate which is common for all bundles, and wherein the bundles are disposed in juxtaposed parallel relationship.

This enables a large number of glue strips to be stored in a practical and space effective fashion, so that said glue strips will easily accessed for use.

The aforesaid object of the invention is also achieved by the third aspect of the invention through the medium of a method of the kind defined in the preamble of claim 13 and comprising the special measures of stacking plies of said glue one upon the other and applying between each ply a glue of a different sort, wherewith this different glue sort has a softening temperature such that the glue will be adhesive at room temperature and such as to form a stack of mutually adhering plies, wherewith the ply stack is cut up into parts in cutting planes that are generally at right angles to the plane of each ply.

This method provides a bundle of glue strips for the purpose given above, in a simple and rational manufacturing method.

According to one preferred embodiment of the method of manufacturing such a bundle, the different glue sort is applied as at least one glue string that extends at an angle to the cutting plane, preferably at right angles.

According to a preferred embodiment, each string consists of a double-sided adhesive tape.

According to another preferred embodiment a woven fabric is applied to one side of each ply prior to stacking the plies together.

The lattermost embodiments afford advantages of the same kind described in respect of corresponding embodiments of the inventive bundle. The aforesaid object of the invention is achieved by the fourth aspect of the invention through the medium of a method of manufacturing a file jacket of the kind defined in the preamble of claim 17, this method including the particular method of providing a file blank and a glue strip, said glue strip comprising said glue and being provided on one side with a layer of a different glue sort, this different glue sort having a softening temperature at which this different glue sort is adhesive at room temperature, wherein the glue strip is stuck to the inner surface of the spine with the aid of the layer of this different glue sort.

This method enables the glue string to be readily applied. This can be done immediately prior to the actual binding step, so that any measures with respect to the file jacket but where the glue strip would otherwise cause a problem can be carried out.

According to one preferred embodiment of this method, graphic is applied to the jacket blank prior to applying the glue strip.

This is an important example of such a measure, where the presence of a glue strip would cause a problem and consequently the inventive method is particularly significant in such a case.

According to another preferred embodiment, the graphic is applied with the aid of a printer.

It is normal for this method to be applied in practice, and hence the advantages afforded by the method are of particular benefit in this respect.

According to another preferred embodiment, the glue strips are provided in the form of mutually adhered glue strips from which a glue strip can be taken.

According to another preferred embodiment, the glue strip is provided with a woven fabric on that side which is opposite to the side on which a layer of said different glue sort is applied.

The advantages achieved with providing a glue strip in this way have been disclosed earlier in connection with the description of the inventive bundle.

The invention also relates to a package for providing glue strips according to the invention. Such as package is characterized in that it contains a plurality of file-jacket blanks and a plurality of glue strips.

The provision of these components in a common packet facilitates logistics on the part of the user, because the components required in manufacturing a file jacket are in a collected state. This will also ensure that glue strips and jacket spines coincide with one another, with regard to length and width.

According to a preferred package embodiment the glue strips are disposed in the form of at least one bundle of the kind according to the present invention. This provides all the advantages afforded by the inventive bundle.

The object of the invention is also achieved by the sixth aspect of the invention in that a blank of the kind defined in claim 24 has the special features wherein the blank is marked on that side intended to form the inside of a file, to show that a glue strip shall be fastened to the spine of the file. Such a mark enables the glue strip to be applied quickly in the correct position, so as to ensure effective binding of the file sheets.

According to one preferred embodiment of the blank, the mark is placed on the spine.

Since the glue strip shall be fastened to the spine, the mark will be most discernible and clear if placed in precisely this position.

According to a further preferred embodiment, the mark is such as to indicate centered location of glue strips on the spine. The best binding result is achieved in this way.

The invention will now be described in more detail with reference to the following description of beneficial embodiments of the invention and with reference to the accompanying figures.

### BRIEF DESCRIPTION OF THE FIGURES

FIG. 1 is a perspective view of a file jacket provided with a glue strip in accordance with the invention.

FIG. 2 is a sectional view of an element shown in FIG. 1.

FIG. 3 is a perspective view of part of a glue strip according to one example of the invention.

FIG. 4 is a side view of a glue strip according to another embodiment of the invention.

FIG. 5 is a perspective view of a bundle according to the invention.

FIG. 6 is a sectioned view of an element shown in FIG. 5.

FIG. 7 is a sectional view similar to FIG. 6 but in larger scale according to an alternative embodiment.

FIG. 8 is a perspective view of a plurality of bundles according to the invention.

FIG. 9 illustrates a manufacturing step in connection with the inventive method.

FIG. 10 illustrates a glue ply from above.

FIG. 11 is a view corresponding to the view of FIG. 10 showing an alternative embodiment.

FIG. 12 is a perspective view of a stack of glue plies.

FIG. 13 is a sectional view of a first embodiment of a package according to the invention.

FIG. 14 is a sectional view of a second example of a package according to the invention.

FIG. 15 is a sectional view of an alternative design of a bundle.

FIG. 16 is a perspective view of a casing blank according to the invention

### DESCRIPTION OF BENEFICIAL EMBODIMENTS

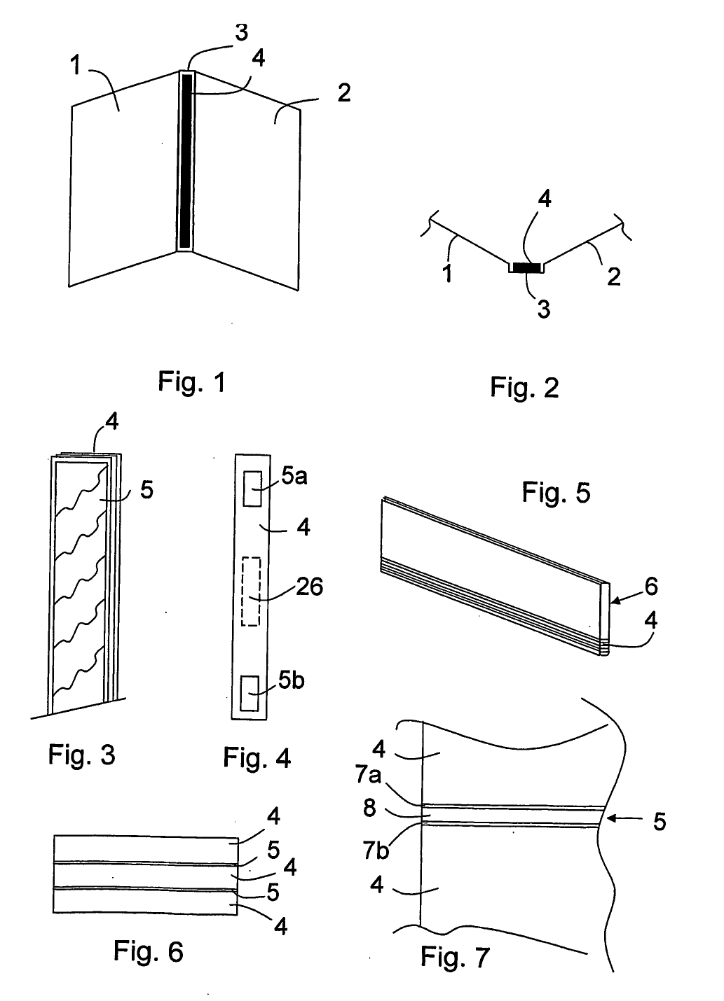

FIG. 1 is a perspective view of a file jacket. The jacket comprises a front page 1, a rear page 2 and a spine 3 which extends between said sides. A glue strip 4 which is rigid at room temperature is fastened to the spine.

As will be seen from FIG. 2, the spine is formed by four fold lines so as to form in the spine 3 a recess for accommodation of the glue strip 4.

FIG. 3 is an enlarged view of part of a glue strip 4 according to the invention. The glue strip 4 is provided on one side with a layer of glue 5, this glue having the ability to act adhesively at room temperature.

FIG. 4 illustrates an alternative embodiment of a glue strip 4. In this case only part of one side is coated with a glue layer 5a, 5b. In the illustrated case two sections of a glue strip are coated, although only one section or a plurality of sections may be coated. The glue strip 4 shown in FIG. 4 also includes an indicator in the form of an aluminium strip 26 embedded in the glue strip. The glue strip 4 is applied to a jacket blank of the kind shown in FIGS. 1 and 2 by pressing a glue strip shown in FIG. 3 or FIG. 4 against the spine 3 of the jacket blank wherewith the glue strip sticks to the spine 3 with the aid of the glue layer 5 and 5a, 5b respectively.

FIG. 5 illustrates a bundle 6 of glue strips according to the invention. The bundle comprises a number of glue strips of the kind illustrated in FIG. 3 or FIG. 4. The glue strips 4 are stuck together with the aid of the glue layer 5, 5a, 5b on one side of each strip 4 so that the bundle will form an integrated unit. A bundle 6 that contains 10-20 strips will have a height of about 5-20 mm. The width of the bundle may vary in accordance with the width of the spine of the jacket blank to which a glue strip shall be applied. This is often in the order of 2-5 mm. The length of the bundle corresponds to the spine length of the files with which the glue strips shall be used. This is often a question of an A4 size or a similar size, which means a length of about 280 mm.

As will be seen from FIG. 6, the bundle 6 comprises thicker layers 4 of the glue that is stiff and inactive at room temperature interspersed with thinner layers 5 of the weaker glue wherein the first mentioned layer is about 0.5-1 mm thick and the latter layer is normally thinner than 0.1 mm. The thinner layer may have the form of a double adhesive tape as illustrated in FIG. 7, where the layer consists of a carrier layer 8 which is coated with glue 7a, 7b on both sides.

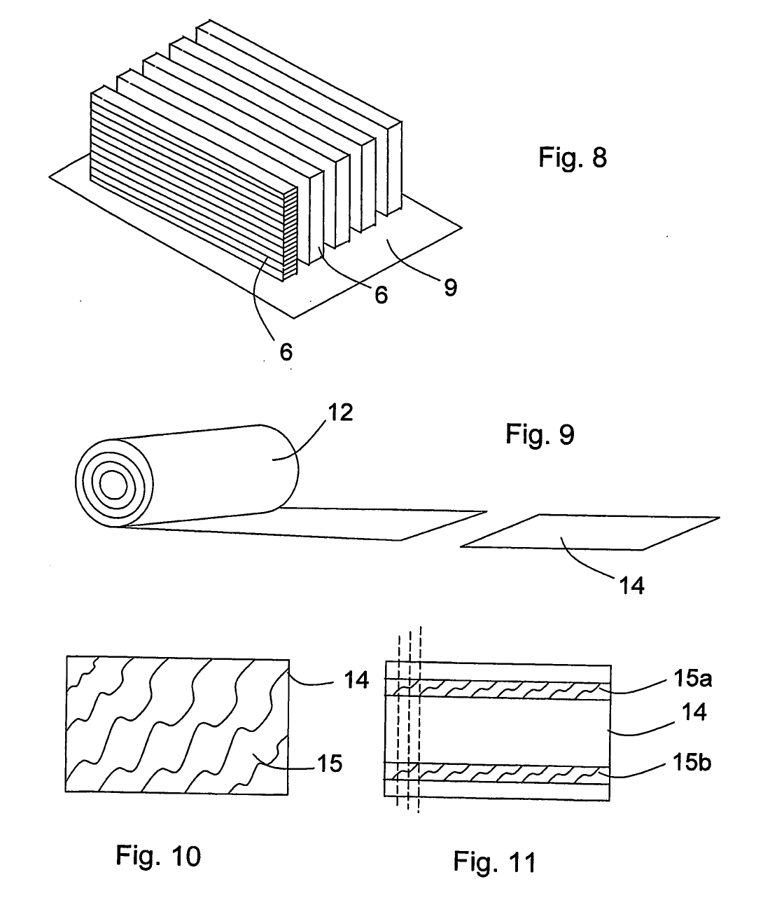

FIG. 8 is a perspective illustration showing how a number of bundles 6 can be arranged on a common substrate 9 with each bundle 6 adhered to the substrate. The bundles 6 are disposed in parallel juxtaposed relationship. In the illustrated case, the bundles are spaced apart. Alternatively they may be disposed close together.

FIGS. 9-12 illustrate different steps in the manufacture of a glue-strip bundle 6. The glue, which may be a typical book binding glue, is available in the form of a roll 12. Plies 14 of the adhesive material are cut from the roll, as shown in FIG. 9.

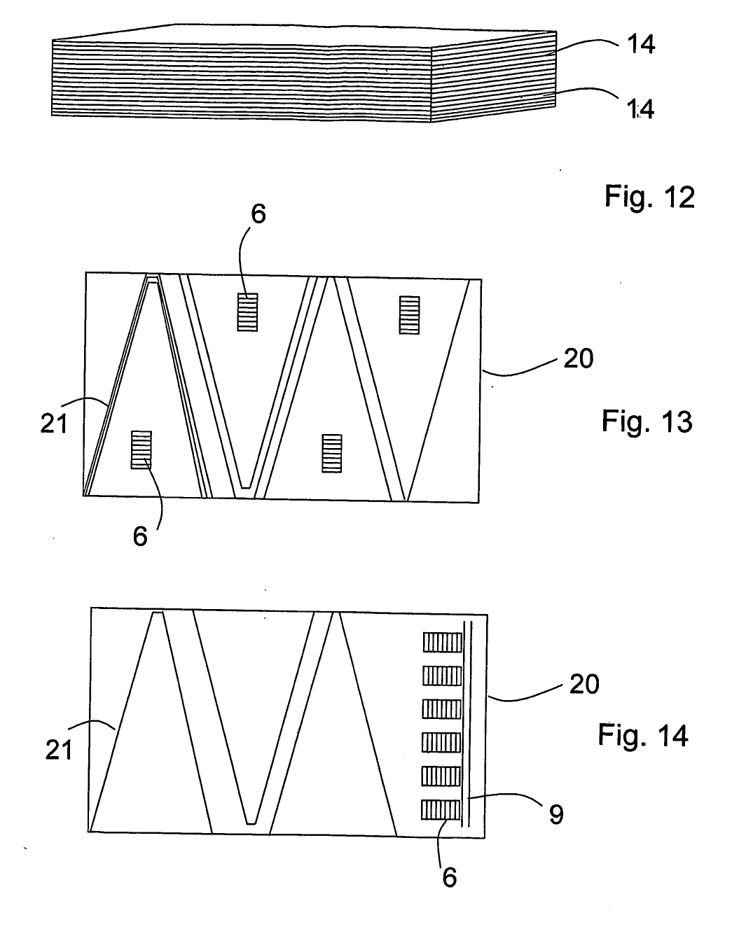

Each ply is then coated with a layer 15 of the glue that is active at room temperature. This means that either the whole of the ply may be coated with such a layer 15 as shown in FIG. 10 or the glue may be applied in strings 15a, 15b as shown in FIG. 11. These may, for instance, consist of double-sided adhesive tape. The plies 14 are then placed on top of one another to form a stack, as shown in FIG. 12, wherewith the plies are held together as a unit by the glue. The stack is then cut into strips at right angles to the plane of the plies such as to form bundles of glue strips.

When the glue has been applied in the form of strings 15a, 15b, as illustrated in FIG. 11, the cuts are made at right angles to these strings, as marked in broken lines in the figure. When a file jacket shall be produced from a jacket blank, a glue strip is taken from the manufactured bundle 6 of glue strips 4. The glue strip 4 removed is then stuck firmly to the inside of the spine 3 of the jacket blank therewith resulting in a file jacket which is ready for binding.

When glue strips that include a woven fabric reinforcement shall be produced, the roll 12 that includes book binder glue is provided with such woven fabric on one side. Alternatively, the woven fabric may be applied to the cut ply 14. If graphic is to be applied to the outside of the file jacket, for instance with the aid of a printer, this is done prior to sticking the glue strip onto the spine.

FIG. 13 illustrates a section of a suitable package, taken through the package. The package contains jacket blanks 21 and glue strip bundles 6. The jacket blanks 21 are slightly V-shaped with a number of blanks inserted one in the other with alternate groups of jacket blanks facing in opposite directions. The bundles are placed in respective parts of the V-shape in a number corresponding to the number of jacket blanks in the group.

FIG. 14 illustrates an alternative embodiment concerning how the jacket blanks 21 and the glue strip bundles 6 are disposed in the package 20. In this case, the bundles 6 are collected to form a unit of the kind shown in FIG. 8.

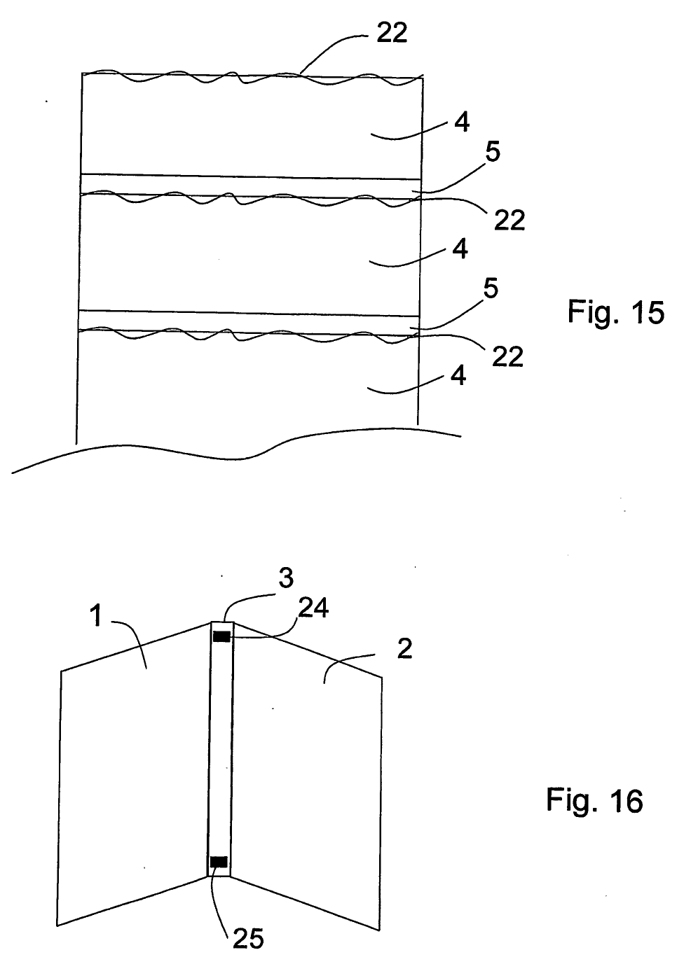

FIG. 15 shows part of a sheet bundle according to an alternative embodiment of the invention. Each glue strip 4 in the bundle is provided on its upwardly facing side, as seen in the figure, with a woven fabric 22 which is partially embedded in the glue strip 4 and lies partially on the surface. Each layer 5 of said different glue sort will then adhere more strongly to the side of a glue strip 4 that lacks woven fabric 22 and less strongly on the side that includes woven fabric.

When the uppermost glue strip 4 is torn loose from the bundle, the glue layer on the underside of said strip will accompany the strip and thereby be loosened from its contact with the side of the underlying glue strip provided with said woven fabric.

FIG. 16 is a perspective view of a file jacket according to the invention. Two markings are printed or punched on the inside of the spine three. These markings 23, 24 indicate where the ends of a glue strip shall be situated. Solely one marking may suffice in this respect.

1. A glue strip (4) adapted for application to the inner surface of the spine (3) of a file-jacket blank, wherein the glue strip (4) includes a glue whose softening temperature is higher than room temperature such that the glue will be inactive at room temperature and active at a higher temperature, characterized in that the glue strip is provided on one side with a layer (5) of a different glue sort, whose softening temperature is such that said different glue sort will be adhesive at room temperature; and in that the glue strip (4) is provided with a woven fabric (22) on that side opposite to the side provided with said layer (5) of a different glue sort.

2. A glue strip (4) according to claim 1, characterized in that said layer (5) is provided on one or more sections (5a, 5b) of said one side of the glue strip (4).

3. A glue strip (4) according to claim 1, characterized in that said layer (5) includes three sub-layers, wherein a first sub-layer (7a) and a second sub-layer (7b) have said given glue softening temperature and a third sub-layer forms an intermediate carrying layer (8).

4. A glue strip (4) according to claim 1, characterized in that the glue strip includes an indicating element.

5. A bundle (6) of glue strips (4), wherewith each glue strip (4) includes a glue whose softening temperature is higher than room temperature such that the glue is inactive at room temperature and active at a higher temperature, characterized in that the glue strips (4) lie adhesively side against side, wherein the adhesion is obtained by means of a layer (5) of a different glue sort located between each pair of mutually abutting sides, wherein said different glue sort has a softening temperature which will cause the different glue sort to be adhesive at room temperature; and that each glue strip is provided with a woven fabric (22) on one of its sides.

6. A bundle (6) according to claim 5, characterized in that said layer (5) is provided on one or more sections (5a, 5b) of said mutually abutting sides.

7. A bundle (6) according to claim 5, characterized in that each layer (5) includes three sub-layers, wherein a first sub-layer (7a) and a second sub-layer (7b) includes said glue that has said given softening temperature, and a third sub-layer that forms an intermediate carrier layer (8).

8. A bundle (6) according to claim 5, characterized in that the number of glue strips (4) in a bundle ranges from 5 to 50 pieces.

9. A bundle (6) according to claim 5, characterized in that the bundle (6) has a height of 2-50 mm, a width of 1-20 mm and a length of 100-400 mm.

10. A bundle (6) according to claim 5, characterized in that the bundle (6) is included in an array of several bundles (6) of mutually the same kind, wherein each bundle firmly adheres to a substrate (9) common to all bundles, and wherein the bundles (6) are juxtaposed parallel to one another.

11. A method of producing a bundle of several glue strips where each glue strip includes a glue whose softening temperature is higher than room temperature, so that the glue will be inactive at room temperature and active at higher temperature, characterized by stacking a plurality of glue plies one upon the other subsequent to having applied a woven fabric on the side of each ply, wherein there is applied between each ply a different glue sort that has a softening temperature at which said different glue sort will become adhesive at room temperature such as to form a stack of mutually adhering plies; and by cutting said ply stack into parts with a cutting plane that is generally at right angles to the plane of each ply.

12. A method according to claim 11, characterized by applying said different glue sort in the form of at least one string that is angled to said cutting plane.

13. A method according to claim 12, characterized in that each adhesive is comprised of double-adhesive tape.

14. A method of manufacturing a file jacket which includes a front sheet, a rear sheet and a spine which extends between said sheets, with the aid of a glue applied to the inner surface of said spine, wherein the glue has a softening temperature that is higher than room temperature so that the glue will be inactive at room temperature and active at a higher temperature, characterized by providing a jacket blank and a glue strip which includes said glue and which is provided on one side with a layer of a different glue sort and which is provided on the other side with a woven fabric, wherein said different glue sort has a softening temperature at which said different glue sort will be active at room temperature, and in that said glue strip is stuck to the inner surface of the spine with the aid of the layer of said different glue sort.

15. A method according to claim 14, characterized by applying graphic to the jacket blank prior to applying the glue strip.

16. A method according to claim 15, characterized by applying the graphic with the aid of a printer.

17. A method according to claim 14, characterized in that the glue strip is obtained by loosening a glue strip from a bundle of mutually adhering glue strips.
